(19) United States
(12) Patent Application Publication
(10) Pub. No.: US 2008/0095048 A1
(43) Pub. Date: Apr. 24, 2008

(54) System and Method for Load Balancing in a Wireless Lan

(75) Inventor: Zhun Zhong, Croton on Hudson, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,878

(22) PCT Filed: Jul. 25, 2005
(86) PCT No.: PCT/IB05/52500

§ 371 Date: Jan. 29, 2007

Related U.S. Application Data
(60) Provisional application No. 60/592,931, filed on Jul. 30, 2004.

(51) Int. Cl. H04L 12/28

(52) U.S. Cl. 370/229

(57) ABSTRACT

A system and method for load balancing in wireless LANs is provided. The system and method uses a new management command comprising a management frame for load balancing purposes. The new “load balancing” management frame comprises a two part frame body: at least one AP Information set and at least one switch condition set. The switch condition set may further comprise specification of a predetermined algorithm.

The present invention relates to a system and method for load balancing in a wireless local area network WLAN. More particularly, the present invention provides a management frame and procedure for its use in balancing traffic among devices participating in a WLAN. Most particularly, the present invention provides a management frame and a procedure for switching traffic among devices of a WLAN to balance their traffic loads.

In recent years, IEEE 802.11 WLAN products have come to dominate the WLAN market. The medium access control (MAC) and physical characteristics for WLANs to support physical layer units are specified and IEEE 802.11 standard, which is defined in International Standard ISO/IEC 8802-11, “Information Technology-Telecommunications and Information Exchange Area Networks,” 1999 Edition, which is hereby incorporated by reference in its entirety.

The IEEE 802.11 standard defines a wireless local area network as having one of two topologies, Infrastructure and Ad Hoc. In the Infrastructure topology, basic network components are wireless stations (STAs) and Access Points (APs) that perform bridging between STAs and external network entities. An AP provides STAs access to a distribution system (DS), connecting a wireless network with at least one external network (Ethernet LANs, Internet). Therefore, the Infrastructure BSS is widely used in enterprise networks. A STA associates with an AP and through the AP communicates with other STAs and a single STA can associate with more than one AP and a STA can roam from one AP to another. In the Ad Hoc topology, each STA communicates with others directly, without the assistance of an AP.

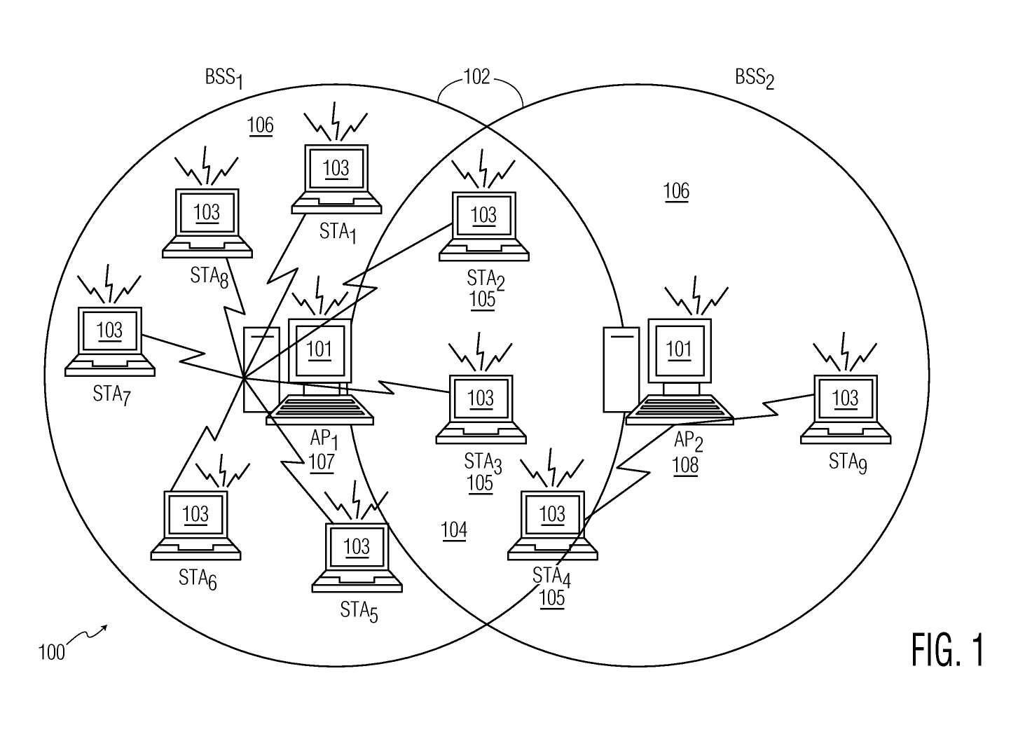

FIG. 1 shows a typical IEEE 802.11 wireless LAN setup in which there are two APs 101 serving two Infrastructure basic service sets (BSSs) 100. The circle 102 around an AP represents the coverage area of the AP 101. STAs 103 within the coverage area of an AP 101 can associate with the AP 101, becoming affiliated with the BSS 102 served by the AP 101. Note that there is an overlapping area 104 of AP coverage in FIG. 1. One or both APs 101 can serve a STA 105 in the overlapping area 104.

Wireless local area networks experience uneven distribution of traffic because there is no mechanism in place to support load balancing among devices of a WLAN. Despite significant advances, today's WLAN still cannot offer the same level of sustained bandwidth as wired counterparts. Prior art algorithms based on received signal strength indicator (RSSI) can result in all STAs 101 being associated with a single or very few APs, 102 thus, degrading overall network performance. For example, in FIG. 1 STA1-STA8 could all be associated with AP1 Because the current IEEE 802.11 wireless LAN standard does not specify how a STA chooses which BSS to associate with.

The access method of IEEE 802.11 MAC is carrier sense multiple access with collision avoidance (CSMA/CA), that employs a listen before talk scheme. A STA with data to transmit must first sense the radio channel and only if the medium is not busy can transmission be undertaken by the STA.

Hence, there is a need in the industry for a system and method for load balancing among APs in a wireless network.

The system and method of the present invention is based on a new management frame sent by an AP to a STA. The present invention provides a system and method for an AP to use the new management frame to inform a STA that it can switch to at least one other AP and also for the AP to provide relevant information to the STA about the conditions under the STA should switch. The STA uses a pre-determined load balancing algorithm to determine if and when to switch and to which AP to switch.

These and other features of the system and method of the present invention will become apparent from the following drawings and detailed description of the present invention.

FIG. 1 illustrates a typical wireless network architecture for overlapping infrastructure BSSs having unbalanced loads whereto embodiments of the present invention are to be applied;

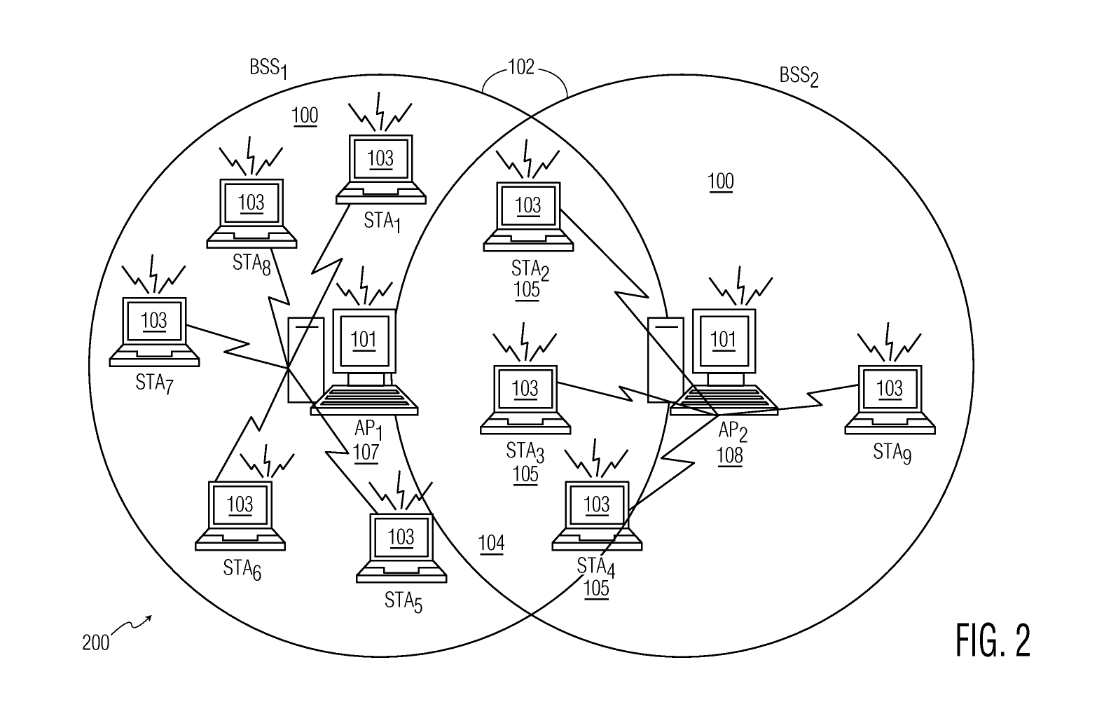

FIG. 2 illustrates the overlapping Infrastructure BSSs of FIG. 1 rebalanced once modified according to an embodiment of the present invention;

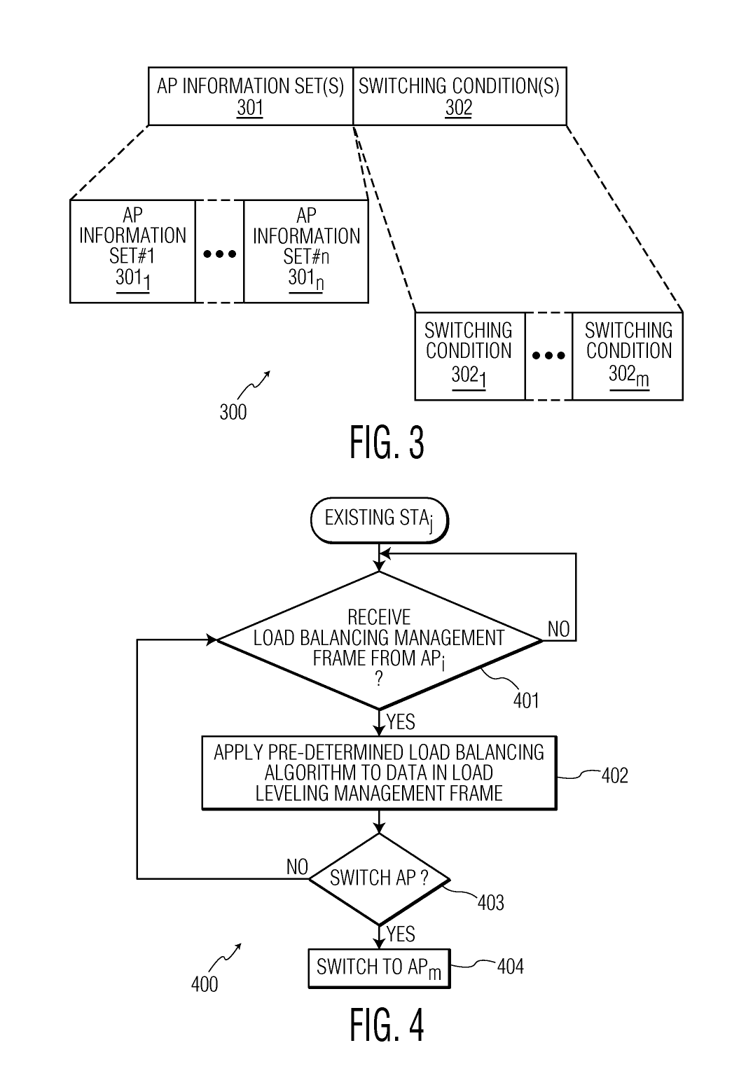

FIG. 3 illustrates a management frame for load balancing according to the present invention;

FIG. 4 illustrates a processing flow executed by a STA when it receives a management frame for load balancing, according to the present invention; and

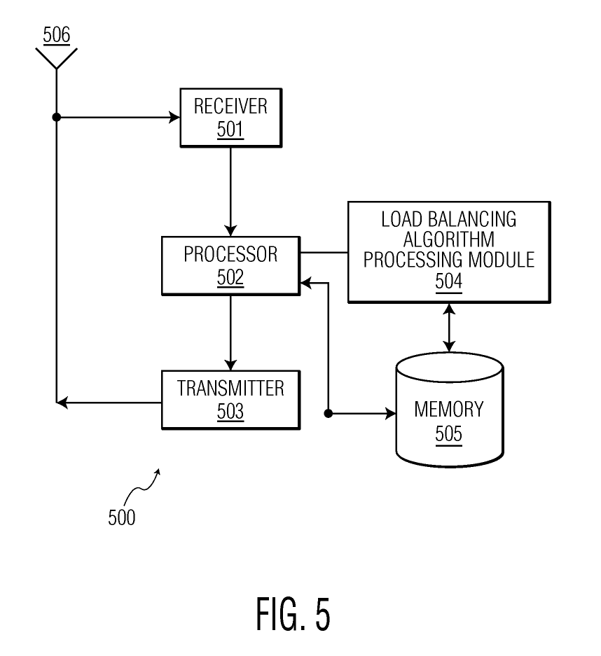

FIG. 5 illustrates an architecture of a wireless device modified according to an embodiment of the present invention.

It is to be understood that these drawings are solely for purposes of illustrating the concepts of the invention and are not intended as a definition of the limits of the invention. The embodiments shown in the figures herein and described in the accompanying detailed description are to be used as illustrative embodiments and should not be construed as the only manner of practicing the invention. Also, the same reference numerals, possibly supplemented with reference characters where appropriate, have been used to identify similar elements.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

FIG. 1 illustrates representative infrastructure wireless communication networks 100 whereto embodiments of the present invention are to be applied. The networks include a plurality of wireless AP devices 101 and a plurality of STAs 103. In the traditional approach, an unbalanced load situation may occur in which STA₁-STA₈ are associated with AP₁ and STA₉ is associated with AP₂. In the traditional approach, the current IEEE 802.11 wireless LAN standard does not specify how a STA chooses which BSS to join. Accordingly, a new station may choose an AP by (1) scanning the medium for attachable APs and recording the received signal strength indicator (RSSI) corresponding to each AP discovered. The result is that neither workload nor bandwidth is shared equally among AP₁ and AP₂ and network capacity is underutilized. A better solution is to balance the load among APs.

The IEEE 802.11 wireless LAN standard does not provide a mechanism for the APs to rebalance the load. According to the system and method of the present invention, it is desirable that AP₁ requests some stations to go to BSS₂. Therefore, it is possible for the scenario illustrated in FIG. 1 to occur, where all the STAs except one are served by one AP, namely AP₁, resulting in an unbalanced load for the two APs.

The system and method of the present invention has application to a wireless local area network (WLAN) by enabling an AP to provide a new management command for all stations (STAs) associated with its BSS. For example, STA₂ of BSS₁ is in an overlapping region 104 with a neighboring BSS₂, thus is a candidate for switching to BSS₂. To this end the present invention introduces a new management command in the form of a new management frame 300 that enables a STA to switch APs when at least one predetermined unbalanced load condition holds.

In a first embodiment, an AP sends a management frame to a STA when the STA first joins the network of the AP. In a second embodiment, load balancing is determined dynamically by the at least one unbalanced condition being discovered by a predetermined algorithm that is executed first by the AP to determine that the load is unbalanced and then by associated STAs to verify that the condition holds for the STA.

The system and method of the present invention adds a command called “load balancing,” which takes the form of a new management frame 300 sent by an AP to a STA. FIG. 3 illustrates a management frame body 300 of this load balancing command comprising a first 301 and a second part 302.

In the first part 301, the command specifies a candidate APᵢ to which the STA receiving this command should switch if the algorithm specified in the second part 302 is satisfied. In its general form, the management frame provides at least one AP as a load balancing candidate from which the STA can choose. Also included in the first part 301 is an information set #i for the specified APᵢ. The information set #i for the at least one APᵢ comprises BSSID, Operating Channel, current load, etc.

In the second part 302, the management frame specifies at least one algorithm under which the STA receiving the command should switch to the specified APᵢ. The algorithm is selected from the set consisting of:

(1) Obtain the RSSI for the corresponding AP in the first part of the frame, and

Switch to the candidate AP in the first part of the management frame if the

RSSI from the candidate AP exceeds a pre -determined threshold; and

(2) Obtain the RSSI for the corresponding AP in the first part of the frame, and

Switch to the candidate AP in the first part of the management frame only if
a. the load of the AP is below a pre-determined threshold, and
b. the RSSI from the candidate AP exceeds a pre-determined threshold;

(3) Obtain the RSSI for the corresponding AP in the first part of the frame, and

Switch to the candidate AP in the first part of the management frame only if
a. the difference between the candidate AP load and current AP load exceeds a pre-determined threshold (i.e., the candidate AP has a significantly lighter load than the current AP), and
b. the RSSI from the candidate AP exceeds a pre-determined threshold.

### If no algorithm is satisfied then the STA remains associated with its current AP.

FIG. 4 illustrates a flow diagram for processing a management frame according to the present invention that is received by a STAⱼ already associated with an APᵢ. STAⱼ senses the medium and receives a management frame 300 from APᵢ at step 401. STAⱼ then processes the received management frame 300 at step 402 and determines whether or not to switch AP at step 403 and either switches to APₘ at step 404 or returns to sensing the medium at step 401.

Referring now to FIG. 5, each AP and STA is modified according to the present invention to perform a load balancing algorithm to determine when a STA should initially join another AP or switch to another AP. According to the principle of the present invention, there is provided a management command enabling an AP 101 to send and a STA 103 to receive a management frame containing at least one AP information set and at least one Switching Condition, e.g., predetermined algorithm. Note that the predetermined algorithm may be identified but not present in a Switching Condition of the management frame. FIG. 2 illustrates the resulting communication system 200 of using the present invention to send a management command for STA₂ 105 and STA₃ 105 to switch to AP₂ 107.

Each wireless device 101 103 within the WLANs 100 shown in FIG. 1 may include a system including an architecture that is illustrated in FIG. 5. Each wireless device 101 103 may include an antenna 506 coupled to a receiver 501 that communicates over the wireless medium. The devices 101 103 each further comprises a processor 502 and a load balancing algorithm module 504. For example, in a STA the processor 502 is configured to receive from the receiver 501 a management frame of one or more AP Information sets 301ᵢ and corresponding Switching Conditions 302ᵢ and to process the management frame using the Load Balancing Algorithm Module 504 to determine whether or not a STA should switch APs. In an AP, the processor 502 is configured to format and send via transmitter 503 a management command (frame) 300 directing a STA to switch to certain APs 301 and specifying conditions 302 for switching, e.g., algorithms to be executed by the STA to determine when to switch APs.

The system and method for a management command for load balancing can be for wireless LANs including IEEE 802.11 WLANs as well as other types of WLANs.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. It is expressly intended that all combinations of those elements that perform substantially the same function in substantially the same way to achieve the same results are within the scope of the invention. Substitutions of elements from one described embodiment to another are also fully intended and contemplated.

We claim:

1. A method of load balancing in a wireless communication system (100) comprising a plurality of access points (APs) (101 107 108) and a plurality of stations (STAs) (103 105) associated therewith, comprising the steps of:
receiving, by a STA (105) from its associated AP (107), a load balancing command (300) comprising at least one AP information set (301) for at least an other AP (108) and at least one switching condition set (302); and
switching by the STA (105) from its associated AP (107) to the at least an other AP (108) based on satisfying one of the at least one switching condition set (302) using the at least one AP Information set (301) and if no algorithm is satisfied then the STA (105) remains associated with its current AP (106).

2. The method of claim 1, wherein the at least one AP Information set (301) comprises at least one information item for an AP (101) chosen from the set consisting of basic service set identifier (BSSID), operating channel, and current load.

3. The method of claim 1, wherein the switching condition set (302) comprises at least one algorithm selected from the group consisting of:
(1) obtaining the RSSI for a corresponding candidate AP from the at least one AP information set (301), and
switching to the candidate AP if the RSSI of the candidate AP exceeds a pre-determined threshold; and
(2) obtaining the RSSI for a corresponding AP in the first part of the frame, and
switching to the candidate AP if
a. the load of the candidate AP is below a pre-determined threshold, and
b. the RSSI of the candidate AP exceeds a pre-determined threshold;
(3) obtaining the RSSI for a corresponding AP from the at least one AP information set (301), and
switching to the candidate AP if
a. the difference between the candidate AP load and current AP load exceeds a pre-determined threshold, and
b. the RSSI of the candidate AP exceeds a pre-determined threshold.

4. The method of claim 3, wherein the at least one AP Information set (301) comprises at least one information item for an AP (101) chosen from the set consisting of basic service set identifier (BSSID), operating channel, and current load.

5. The method of claim 1, wherein the load balancing command is a management frame (300) comprising the at least one AP Information set (301) and the at least one corresponding switching condition set (302).

6. The method of claim 5, wherein the at least one AP Information set (301) comprises at least one information item for an AP (101) chosen from the set consisting of basic service set identifier (BSSID), operating channel, and current load.

7. The method of claim 6, wherein the at least one corresponding switching condition set (302) comprises at least one algorithm selected from the group consisting of:
(1) obtaining the RSSI for a corresponding candidate AP from the at least one AP information set (301), and switching to the candidate AP if the RSSI of the candidate AP exceeds a pre-determined threshold; and
(2) obtaining the RSSI for a corresponding AP in the first part of the frame, and
switching to the candidate AP if
a. the load of the candidate AP is below a pre-determined threshold, and
b. the RSSI of the candidate AP exceeds a pre-determined threshold;
(3) obtaining the RSSI for a corresponding AP from the at least one AP information set (301), and
switching to the candidate AP if
a. the difference between the candidate AP load and current AP load exceeds a pre-determined threshold, and
c. the RSSI of the candidate AP exceeds a pre-determined threshold.

8. A method of load balancing in a wireless communication system (100) comprising a plurality of access points (APs) (101 101 108) and a plurality of stations (STAs) (103 105) associated therewith, comprising the steps of:
sending by an AP (107) to an associated STA (103 105), a load balancing command (300) comprising at least one AP information set (301) for at least an other AP (108) and at least one corresponding switching condition set (302); and
switching by the STA (105) from its associated AP (107) to the at least an other AP (108) based on satisfying one of the at least one corresponding switching condition set (302) using the Information set (302) of the at least an other AP (108).

9. The method of claim 8, wherein the at least one AP Information set (301) comprises at least one information item for an AP chosen from the set consisting of basic service set identifier (BSSID), operating channel, and current load.

10. The method of claim 8, wherein the at least one corresponding switching condition set (302) comprises at least one algorithm selected from the group consisting of:
(1) obtaining the RSSI for a corresponding candidate AP from the at least one AP information set (301), and
switching to the candidate AP if the RSSI of the candidate AP exceeds a pre-determined threshold; and
(2) obtaining the RSSI for a corresponding AP in the first part of the frame, and
switching to the candidate AP if
a. the load of the candidate AP is below a pre-determined threshold, and
b. the RSSI of the candidate AP exceeds a predetermined threshold;
(3) obtaining the RSSI for a corresponding AP from the at least one AP information set (301), and
switching to the candidate AP if
a. the difference between the candidate AP load and current AP load exceeds a pre-determined threshold, and
b. the RSSI of the candidate AP exceeds a pre-determined threshold.

11. The method of claim 10, wherein the at least one AP Information set (301) comprises at least one information item for an AP (101 107 108) chosen from the s et consisting of basic service set identifier (BSSID), operating channel, and current load.

12. The method of claim 8, wherein the load balancing command is a management frame (300) comprising the at least one AP Information set (301) and at least one corresponding switching condition set (302).

13. The method of claim 12, wherein the at least one AP Information set (301) comprises at least one information item for an AP chosen from the set consisting of basic service set identifier (BSSID), operating channel, and current load.

14. The method of claim 13, wherein the at least one corresponding switching condition set (302) comprises at least one algorithm selected from the group consisting of:
(1) obtaining the RSSI for a corresponding candidate AP from the at least one AP information set (301), and
switching to the candidate AP if the RSSI of the candidate AP exceeds a pre-determined threshold; and
(2) obtaining the RSSI for a corresponding AP in the first part of the frame, and
switching to the candidate AP if
a. the load of the candidate AP is below a pre-determined threshold, and
b. the RSSI of the candidate AP exceeds a pre-determined threshold;
(3) obtaining the RSSI for a corresponding AP from the at least one AP information set (301), and
switching to the candidate AP if
a. the difference between the candidate AP load and current AP load exceeds a pre-determined threshold, and
b. the RSSI of the candidate AP exceeds a pre-determined threshold.

15. An apparatus for switching by a station (STA) (103 105) from one access point (AP) (101 107 108) to another AP, comprising:
a receiver (501) operative to receive a load balancing command (300) comprising at least one Information set (301) for an AP and at least one corresponding switching condition set (302);
a load balancing algorithm processing module (504) that uses the at least one AP Information Set (301) with at least one pre-determined algorithm to determine when the at least one corresponding switching condition (302) set has been met;
a transmitter (503) operative to transmit messages; and
a processor (502) operatively coupled to the receiver (501), the load balancing algorithm module (504) and the transmitter (503) and configured to accept the received load balancing command (300), direct the load balancing algorithm processing module to process said command to determine a new AP (108), if any, the STA (105) should switch to, and direct the transmitter (503) to transmit a management frame (300) to switch the STA (105) to the new AP (108).

16. The apparatus of claim 15, wherein the at least one Information set for an AP comprises at least one information item for an AP chosen from the set consisting of basic service set identifier (BSSID), operating channel, and current load.

17. The apparatus of claim 15, wherein the at least one switching condition set (302) comprises at least one algorithm selected from the group consisting of:
(1) obtain the RSSI for a corresponding candidate AP from the at least one AP information set (301), and
switch to the candidate AP if the RSSI of the candidate AP exceeds a pre - determined threshold; and
(2) obtain the RSSI for a corresponding AP in the first part of the frame, and
switch to the candidate AP if
a. the load of the candidate AP is below a pre-determined threshold, and
b. the RSSI of the candidate AP exceeds a predetermined threshold;
(3) obtain the RSSI for a corresponding AP from the at least one AP information set (301), and
switch to the candidate AP if
a. the difference between the candidate AP load and current AP load exceeds a pre-determined threshold, and
b. the RSSI of the candidate AP exceeds a pre-determined threshold.

18. The apparatus of claim 17, wherein the at least one Information set (301) for an AP comprises at least one information item for an AP chosen from the set consisting of basic service set identifier (BSSID), operating channel, and current load.

19. The apparatus of claim 15, wherein the load balancing command is a management frame comprising the at least one Information set (301) for an AP and the at least one corresponding switching condition set (302).

20. The apparatus of claim 19, wherein the at least one Information set (301) for an AP comprises at one item for an AP chosen from the set consisting of basic service set identifier (BSSID), operating channel, and current load.

21. The apparatus of claim 20, wherein the at least one corresponding switching condition set (302) comprises at least one algorithm selected from the group consisting of:
(1) obtain the RSSI for a corresponding candidate AP from the at least one AP information set (301), and
switch to the candidate AP if the RSSI of the candidate AP exceeds a pre-determined threshold; and
(2) obtain the RSSI for a corresponding AP in the first part of the frame, and
switch to the candidate AP if
a. the load of the candidate AP is below a pre-determined threshold, and
b. the RSSI of the candidate AP exceeds a pre-determined threshold;
(3) obtain the RSSI for a corresponding AP from the at least one AP information set (301), and
switch to the candidate AP if
a. the difference between the candidate AP load and current AP load exceeds a pre-determined threshold, and
b. the RSSI of the candidate AP exceeds a pre-determined threshold.
